(19) United States
(12) Patent Application Publication
(10) Pub. No.: US 2024/0054892 A1
(43) Pub. Date: Feb. 15, 2024

(54) SYSTEM AND METHOD TO DETECT TAILGATING VEHICLE ON HIGH SPEED ROAD FROM A MOVING VEHICLE

(71) Applicant: ELM, Riyadh (SA)

(72) Inventors: Athul M. MATHEW, Riyadh (SA); Thariq KHALID, Riyadh (SA); Riad SOUISSI, Riyadh (SA)

(73) Assignee: ELM, Riyadh (SA)

(21) Appl. No.: 18/173,126

(22) Filed: Feb. 23, 2023

Related U.S. Application Data
(60) Provisional application No. 63/397,049, filed on Aug. 11, 2022.

(51) Int. Cl. G08G 1/017; G08G 1/01; G08G 1/052

(52) U.S. Cl. CPC G08G 1/0175; G08G 1/0137; G08G 1/052

(57) ABSTRACT

A tailgating detection system and method includes a single monocular camera, an embedded computer system for determining a tailgating event based on images captured by the camera, the determining of the tailgating event including detecting and tracking wheels of front and tailgating vehicle candidates and determining respective speeds relative to a speed of a vehicle that the camera is mounted and using frame rate of the camera, a location determining device for determining the location where the tailgating event occurred, and a communication unit for transmitting a notification of the tailgating event including the location where the tailgating event occurred.

### CROSS-REFERENCE TO RELATED APPLICATIONS

This application claims the benefit of priority to provisional application No. 63/397,049 filed Aug. 11, 2022, the entire contents of which are incorporated herein by reference.

This application is related to Attorney Docket No. 545857US titled “Ego Vehicle Speed Estimation”, the entire contents of which are incorporated herein by reference.

### STATEMENT REGARDING PRIOR DISCLOSURE BY THE INVENTORS

Aspects of this technology are described in Mathew, Athul M., and Thariq Khalid, “Ego Vehicle Speed Estimation using 3D Convolution with Masked Attention,” arXiv preprint arXiv:2212.05432 (2022), and is incorporated herein by reference in its entirety.

### BACKGROUND

### Technical Field

The present disclosure is directed to a tailgating detection system and method that includes a single vehicle mounted monocular camera and an embedded computer device. The embedded computer device estimates the speed of the vehicle on which the tailgating detection system is mounted and two or more external vehicles based on continuous video captured by the camera and uses the estimated speeds together with other information in images of the external vehicles to measure a distance between forward and following external vehicles. The embedded computer device determines whether the measured distance is less than a safe distance for the estimated speeds, and if so, records the event as a tailgating event.

### Description of Related Art

Vehicle tailgating is a scenario in which a vehicle approaches another vehicle from the back on a high-speed road without maintaining a safe distance. This type of scenario is a cause of traffic accidents, often with serious injuries. A safe distance on high-speed roads is usually defined by the distance that a vehicle can travel in 2 seconds at a given speed without crashing into the vehicle in front of it. US Patent Application No.: 2010/0302371 represents a conventional solution in which cameras fitted on a back side of a front vehicle face backwards in order to determine whether a following vehicle is approaching at an unsafe speed and/or distance, and thus may be tailgating. Another solution includes a CCTV camera fixed at an elevated position (e.g., on a tall pole) on the side of a highway. The CCTV camera captures the occurrence of tailgating at a particular location. This later solution is a highly constrained situation where tailgating is detected only at the location where the CCTV camera mounted and/or directed. The later solution is not practical to implement since it would require the installation of CCTV cameras for this purpose at many locations on high-speed roads.

Yet another solution is described in GB 2560110 in which eight cameras are mounted on a patrol vehicle. A problem with this approach is that all of the cameras must be in sync with each other to capture an image at the right time. Even if only the left camera is taking video, a patrol vehicle on which the cameras are mounted would not legally be able to catch up with the speed of the target vehicles on the high-speed lane as the law of some countries requires that the vehicle in violation must be at least 10 km/hr faster than the patrol vehicle. Also, typically many vehicles may be in front of the patrol vehicle thus blocking movement of the patrol vehicle. This blockage will hinder the capturing of the video footage by some of the cameras, such as those on the left side of the patrol vehicle. Thus, the eight-camera configuration is not a practical solution.

In order to address the shortcomings of conventional tailgate detection systems one object of the present disclosure is to provide a tailgating detection system that can be mounted on a patrol vehicle to detect and track vehicles as candidate tailgating vehicles. The tailgating detection system includes a single monocular video camera and an edge computing device. The single camera faces forward such that images of vehicles preceding the patrol car on a roadway can be captured. The system uses an AI model to detect and track wheels of the front and tailgating cars and to determine the speed of the patrol vehicle.

### SUMMARY

An aspect of the present disclosure is a tailgating detection system, that cana single monocular camera mounted on a monitor vehicle; an embedded computer system for determining a tailgating event based on images captured by the camera, the determining of the tailgating event including detecting and tracking wheels of at least one front candidate vehicle and at least one tailgating candidate vehicle and determining the respective speeds of the front and tailgating vehicle candidates relative to a speed of the monitor vehicle and using a frame rate of the camera, wherein the embedded computer system is present in or on the monitor vehicle; a location determining device, present in or on the monitor vehicle, for determining the location where the tailgating event occurred; and a communication unit, present in or on the monitor vehicle, for transmitting a notification of the tailgating event including the location where the tailgating event occurred.

A further aspect of the present disclosure is a method of tailgating detection, that can include capturing images of a scene in front of a monitor vehicle using a single monocular camera mounted on the monitor vehicle; determining a tailgating event based on the captured images, including detecting and tracking wheels of at least one front candidate vehicle and at least one tailgating candidate vehicle and determining the respective speeds of the front and tailgating candidates relative to a speed of the monitor vehicle and using a frame rate of the camera, wherein an embedded computer system is present in or on the monitor vehicle; determining, by a location determining device present in or on the monitor vehicle, a location where the tailgating event occurred; and transmitting, by a communication unit present in or on the monitor vehicle, a notification of the tailgating event including the location where the tailgating event occurred.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a scenario for a front vehicle and a candidate tailgating vehicle;

FIG. 2 illustrates a view from a front facing video camera;

FIG. 3 is a top view of an exemplary vehicle having video cameras mounted thereon;

FIG. 4 is a block diagram of a hardware implementation of a tailgating detection system in accordance with an exemplary aspect of the disclosure;

FIG. 5A illustrates an exemplary edge computing device. FIG. 5B illustrates an exemplary USB dashcam;

FIG. 6 is a flowchart of a tailgating detection method, in accordance with an exemplary aspect of the disclosure;

FIG. 7 is a flow diagram of vehicle speed estimation, in accordance with an exemplary aspect of the disclosure;

FIG. 8 is a block diagram of a deep learning network for vehicle speed estimation, in accordance with an exemplary aspect of the disclosure;

FIG. 9 illustrates bounding boxes for vehicle detection, in accordance with an exemplary aspect of the disclosure;

FIG. 10 illustrates wheel detection, for vehicle speed and distance estimation;

FIG. 11 illustrates wheel detection across video frames, in accordance with an exemplary aspect of the disclosure;

FIG. 12 illustrates wheel detection for distance estimation, in accordance with an exemplary aspect of the disclosure;

FIG. 13 illustrates distance estimation between vehicles, in accordance with an exemplary aspect of the disclosure;

FIG. 14 illustrates details of distance estimation between vehicles, in accordance with an exemplary aspect of the disclosure;

FIG. 15 is a block diagram of a tailgating detection system, in accordance with an exemplary aspect of the disclosure;

FIG. 16 illustrates distance estimation of vehicles captured with the video camera;

FIG. 17 illustrates distance estimation of vehicles captured with the video camera;

FIG. 18 is an illustration of a non-limiting example of details of computing hardware used in the computing system, according to aspects of the present disclosure;

FIG. 19 is an exemplary schematic diagram of a data processing system used within the computing system, according to aspects of the present disclosure;

FIG. 20 is an exemplary schematic diagram of a processor used with the computing system, according to aspects of the present disclosure; and

FIG. 21 is an illustration of a non-limiting example of distributed components that may share processing with the controller, according to aspects of the present disclosure.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “approximate,” “about,” and similar terms generally refer to ranges that include the identified value within a margin of 20%, 10%, or preferably 5%, and any values therebetween.

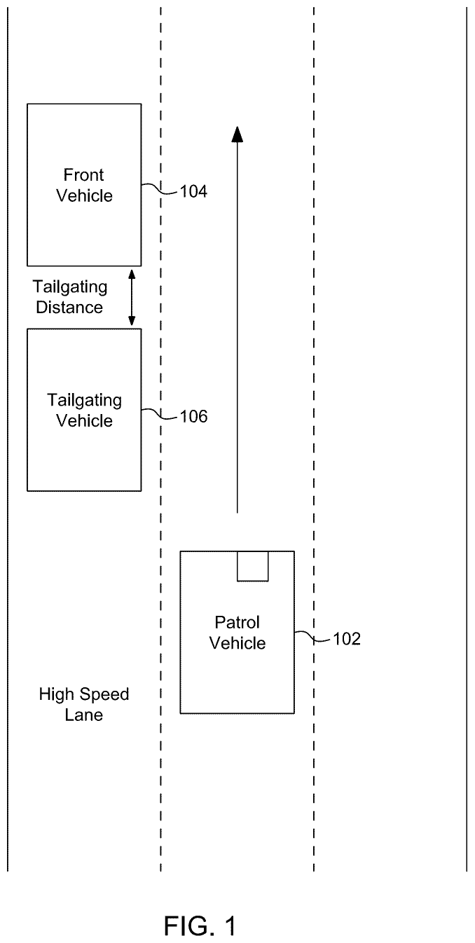

FIG. 1 illustrates a scenario for a front vehicle and a candidate tailgating vehicle. During operation, a patrol vehicle 102 (e.g., a monitor vehicle and/or a vehicle n which a tailgate detection system is mounted) will be traveling in the lane just one lane over from the high-speed lane and preferably neighboring the high-speed lane in a road system which permits exchange between the respective lanes. In one scenario, the patrol vehicle 102 is seeking candidate tailgating vehicles, as tailgating is a dangerous driving condition. Tailgating can be quantified in terms of distance between front vehicle 104 and following vehicle 106 and speed of the two vehicles. For example, a distance of 5 meters or less, 4 m or less, 3 m or less, 2 meter or less, or less than 1 m. The threshold for defining tailgating may depend on the speed of travel of a lead car. In addition, the patrol vehicle 102 is traveling at a certain speed in a slower traveling lane. FIG. 1 illustrates the scenario for a front vehicle 104 and a candidate tailgating vehicle 106 behind the front vehicle, and the patrol vehicle 102 one lane over. The term “patrol vehicle” as used herein may include a vehicle directed by or driven by a government official in support of law enforcement activities. In other embodiments a patrol vehicle is any vehicle such as a passenger vehicle, marked or unmarked, privately owned or otherwise, driven by an individual or autonomously directed, on which the camera is mounted.

In an embodiment of the present tailgating detection system and method, a patrol vehicle 102 is equipped with an edge device and one video camera, e.g., one video camera connected to the edge device. The camera, which can be placed on the windshield, dashboard, or front body panel, faces forward or at an angle such that images of the vehicles going ahead in the high-speed lane can be captured.

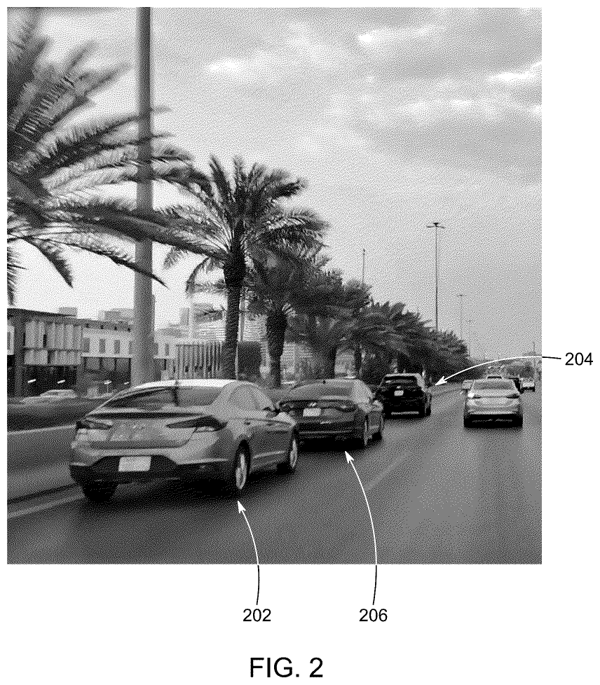

FIG. 2 illustrates a view from a front facing video camera. As illustrated in FIG. 2, when the patrol vehicle is in motion, it repeatedly captures images of the high-speed lane 202 to monitor vehicles 204 on the road forward of the patrol vehicle. The road forward of the patrol vehicle has lane lines, broke or solid, 206 to mark the division between lanes, as well as to indicate that vehicles can move between lanes.

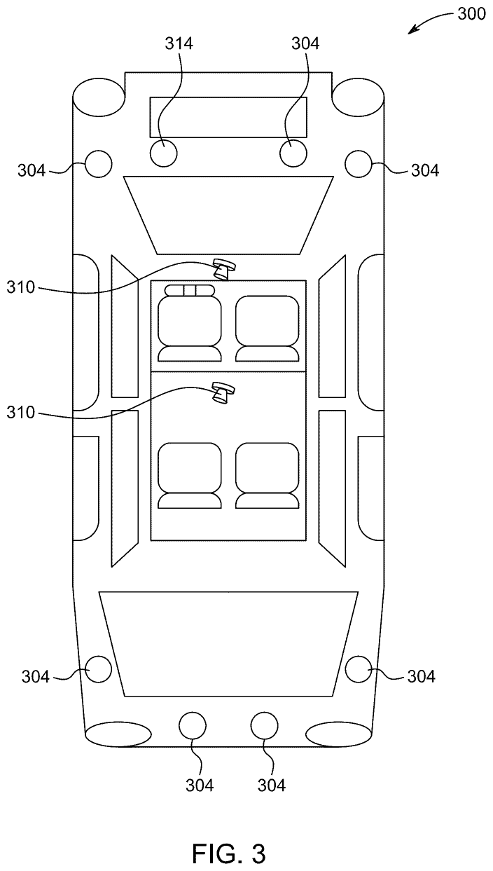

FIG. 3 is a top view of an exemplary vehicle equipped with an edge device and various cameras mounted thereon. The vehicle can be of any make in the market. A non-limiting vehicle can be equipped with a number of exterior cameras 304 and interior cameras 310. One camera 314 for tailgating detection can be mounted on the front dash, the front windshield, or embedded on the front portion of the exterior body and/or on the patrol vehicle roof in order to capture images in front of the patrol vehicle for external vehicles in an adjacent, high-speed, lane. The camera is preferably mounted integrally with a rearview/side mirror on the driver's side of the patrol vehicle on a forward-facing surface (i.e., facing traffic preceding the patrol vehicle). In this position the camera is generally oriented within the view of an individual inside the patrol vehicle such that a patrol officer can concurrently check for oncoming traffic behind the patrol vehicle using the rearview side mirror and monitor the position of preceding vehicles.

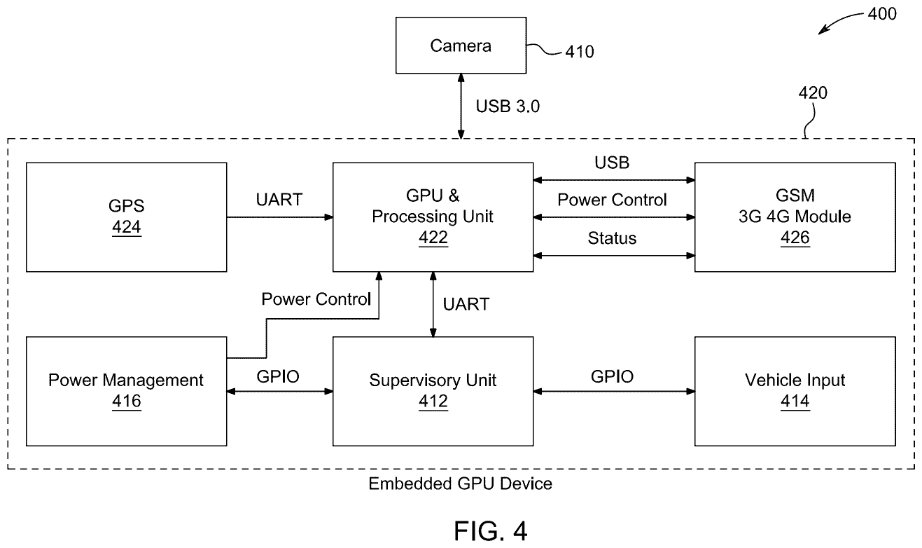

FIG. 4 is a block diagram of a hardware implementation of a tailgating detection system in accordance with an exemplary aspect of the disclosure. The tailgating detection apparatus 400 includes an image/video capturing device (video camera 410) and an edge computing device 420. The video camera 410 is capable of capturing a sequence of image frames at a predetermined frame rate. The frame rate may be fixed or may be adjusted in a manual setting, or be set based on the mode of image capture. For example, a video camera may have an adjustable frame rate for image capture, or may automatically set a frame rate depending on the type of image capture. A burst image may be set for one predetermined frame rate, while video capture may be set for another predetermined frame rate.

The edge computing device 420 is configured as an embedded processor for tailgating detection. In one embodiment, the edge computing device 420 is a portable, or removably mounted, computing device which is equipped with a Graphical Processing Unit (GPU) or a type of machine learning engine, as well as a general purpose central processing unit (CPU) 422, and its internal modules. The edge computing device 420 provides computing power that is sufficient for machine learning inferencing in real time for tasks including tailgating detection, vehicle speed estimation, and object detection, preferably all with a single monocular camera. Internal modules can include communication modules, such as Global System for Mobile Communication (GSM) 426 and Global Positioning System (GPS) 424, as well as an input interface 414 for connection to the vehicle network (Controller Area Network, CAN). A supervisory unit 412 may control input and output communication with the vehicle internal network. In one embodiment, the GPU/CPU configured edge device 400 is an NVIDIA Jetson Series (including Orin, Xavier, Tx2, Nano) system on module or an equivalent high-performance processing module from any other manufacturer like Intel, etc. The video camera 410 may be connected to the edge device 420 by a plug-in wired connection, such as USB, or may communicate with the edge computing device 420 by a wireless connection, such as Bluetooth Low Energy, depending on distance to the edge device and/or communication quality in a vehicle. This set up is powered by the vehicle's battery as a power source. A power management component 416 may control or regulate power to the GPU/CPU 422, on an as needed basis.

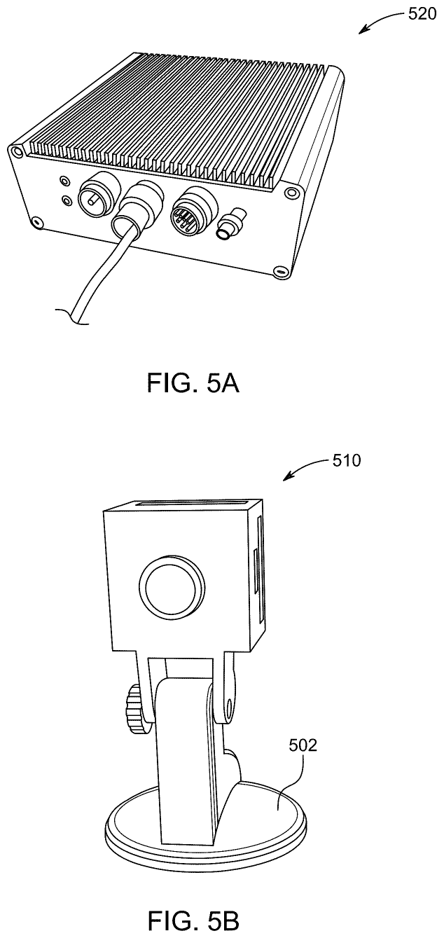

An exemplary edge computing device with enclosure 520 is shown in FIG. 5A. FIG. 5B illustrates a USB camera 510 with a base that can be attached to the rearview mirror, side mirror, windshield, dashboard, front body panel, or roof of the patrol vehicle 102. The camera 510 can be a USB camera for connection to the edge computing device by a USB cable. The USB camera 510 may be of any make which can channel a video stream. In one embodiment, the tailgate detection apparatus is an all-in-one portable module that is removably mounted on a patrol vehicle 102. Preferably the all-in-one portable module has a camera back plate which is curved to generally match the contours of the forward-facing surface of a side view mirror, e.g., an ovoidal shape having a flat inner surface matching the contours of the forward face of the side view mirror and a curved dome-like front surface with the camera lens/opening located at an apex of the dome shape. The back plate is optionally integral with a neck portion that terminates in a thin plate having a length of 5-20 cm which can be inserted into the gap between the window and patrol vehicle door to secure the all-in-one portable module to the patrol vehicle. A cable and/or wireless capability may be included to transfer captured images to the edge device while the patrol vehicle is moving.

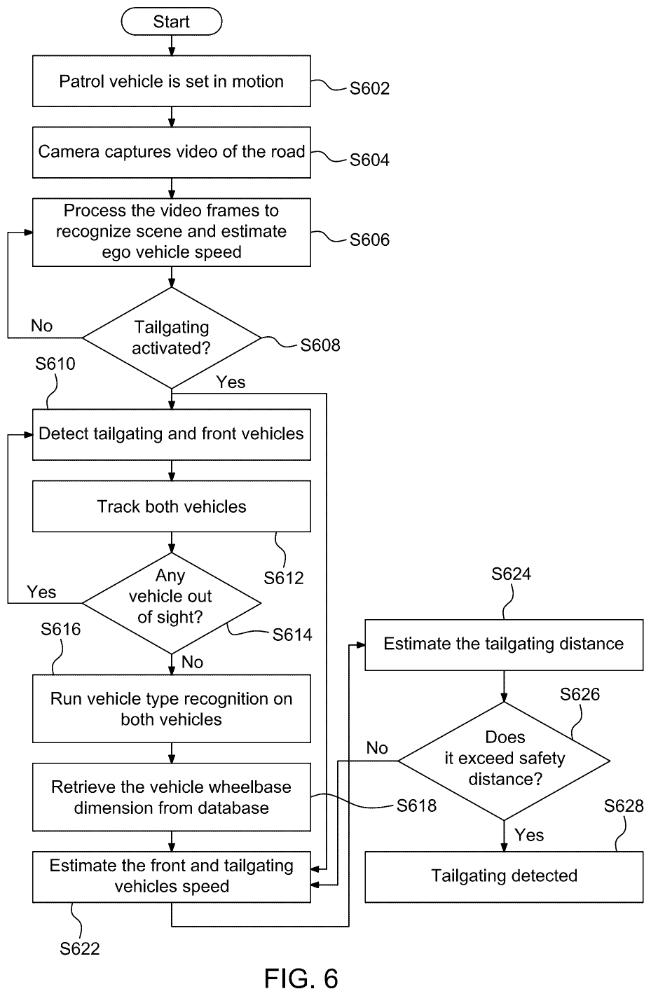

FIG. 6 is a flowchart of a method of tailgating detection, in accordance with an exemplary aspect of the disclosure. The method is based on an ego-vehicle, which in one embodiment is a patrol vehicle 102, and a front vehicle 104 and a candidate tailgating vehicle 106. For purposes of this disclosure, an ego-vehicle is a vehicle that contains the sensor (camera) or sensors that perceive the environment around the vehicle. An ego vehicle may include, may be connected to or may be reliant on an egocentric coordinate system where the vehicle is always at the center of the perceived world. The patrol vehicle 102 contains a camera to perceive the environment forward of the vehicle in the direction of a high-speed lane.

As the patrol vehicle 102 traverses along a highway, S602, the camera mounted on the patrol vehicle 102, in S604, captures video of the road. Since the road is a highway for high-speed driving, it has lane line markings, as well as markings to indicate the edge of the road. The lane line markings are typically white broken lines substantially equally spaced apart. In some cases, the white broken line may have an adjacent continuous line. The various road markings may be used by the ego-vehicle for guiding the vehicle as well as for vehicle speed measurement.

In S606, as the patrol vehicle 102 travels along the highway, the edge computing device 420 processes the captured video frames to recognize the scene in front of the vehicle and estimate the speed of the patrol vehicle.

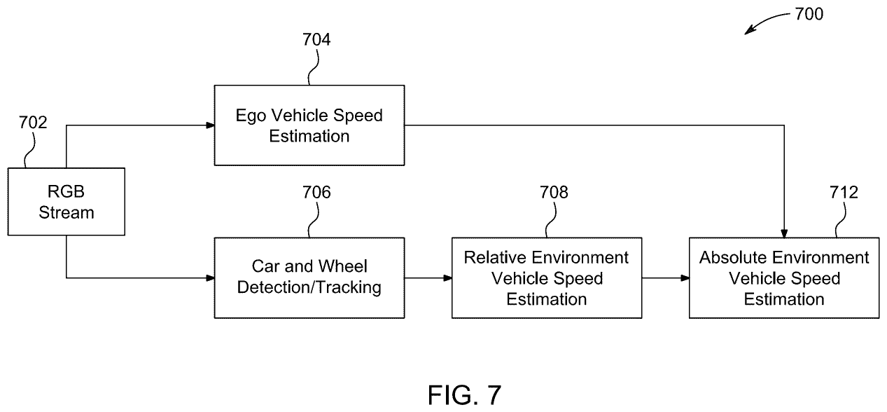

FIG. 7 is a flow diagram of vehicle speed estimation, in accordance with an exemplary aspect of the disclosure. A speed estimation module 700 estimates the speed of the patrol vehicle 102, and can estimate the speed of environment vehicles including front vehicle 104 and rear vehicle 106, using a video stream 702. Differences in speed of the front vehicle 104 and rear vehicle 106 can be used in determining whether the rear vehicle 106 is a candidate tailgating vehicle. In one embodiment, the speed of the patrol vehicle 102 is determined in a vehicle speed estimation component 704. In the embodiment, the estimation of the speed of the front vehicle 104 and of the candidate tailgating vehicle 106 is determined relative to the speed of the patrol vehicle 102 using a car and wheel detection/tracking component 706, relative environment vehicle speed estimation component 708, and an absolute environment vehicle speed estimation component 712.

Vehicle Speed Estimation:

The tailgating detection apparatus 400 estimates the speed of the vehicle on which the apparatus is mounted. The speed of the vehicle on which the apparatus is mounted can be obtained using internal sensors through the vehicle CAN bus. In another aspect, the speed of the vehicle is determined using images of the road or other objects along the road obtained as the vehicle is moving. In one embodiment, images of the road are used to detect lane line markings in the road. Image frames containing lane line markings are used to determine the speed of the vehicle.

However, detection of lane line markings while moving is a challenging task for most general purpose computers and cannot be performed in real time. Even a high performance computer must be capable of capturing the spatio-temporal features of videos that are spread across multiple continuous frames. State of the art computer vision systems can perform object detection, but primarily specialize in spatial aspects of single images. Typically computer vision systems classify images, or may classify objects within images. Some computer vision systems can handle spatio-temporal features. Some computer vision systems can handle action recognition, e.g., types of human action or object actions. Very little work has been performed for action recognition from the perspective of the device that the camera is mounted (i.e., the camera is mounted to the moving device).

Embodiments of the tailgating detection apparatus utilize a speed estimation module. The speed of the vehicle can be obtained through the vehicle's own sensors, e.g., speedometer, which can be read through the CAN bus. In electronic speedometers, a rotation sensor mounted in the transmission delivers a series of electronic pulses whose frequency corresponds to the (average) rotational speed of the driveshaft, and therefore the vehicle's speed. The sensor is typically a set of one or more magnets mounted on the output shaft or (in transaxles) differential crown wheel, or a toothed metal disk positioned between a magnet and a magnetic field sensor. As the part in question turns, the magnets or teeth pass beneath the sensor, each time producing a pulse in the sensor as they affect the strength of the magnetic field it is measuring. The pulses coming from the sensors communicate to the instrument panel via the CAN Bus.

On the other hand, visual vehicle information can provide spatial aspects and other features such as localization, anomalies, relative motion between adjacent vehicles, to name a few. Visual vehicle information can be obtained using a computer vision system. Computer vision tasks include methods for acquiring, processing, analyzing and understanding digital images, and extraction of high-dimensional data from the real world in order to produce numerical or symbolic information. Computer vision systems presently include machine learning techniques, such as regression analysis, multi-layer neural networks, convolutional neural networks (CNNs) or vision transformers (ViTs). CNNs have been developed for image classification and object detection within an image. An example of CNN for computer vision applications includes Residual Network (ResNet). ViTs are seen as a potential replacement for CNNs. ViTs lack aspects that are present in CNNs, such as inductive bias. Also, ViTs typically do not scale well with larger image resolutions.

A recent enhancement in CNN has been to include temporal features. A non-limiting example of a CNN that includes temporal features is referred to as 3D CNN, and can handle spatio-temporal features of a sequence of images. Also, a non-limiting example of a comparable video transformer architecture, known as Video Vision Transformer (ViViT), can handle 3D vision to take into account temporal features across multiple continuous frames.

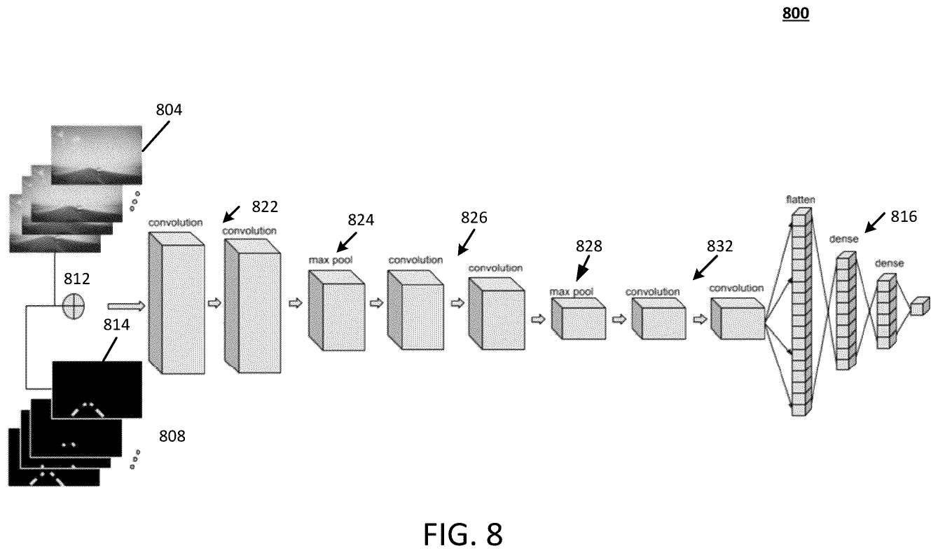

FIG. 8 is a schematic diagram of a 3D-CNN deep learning network, in accordance with an exemplary aspect of the disclosure. The 3D-CNN 802 includes a mask 808 to focus on relevant features.

The network 800 includes a concatenation 812 of the masked attention 808 as an additional channel to the input grayscale image 804. The input to the model 802 is the concatenated image 814. All convolutional 3D layers 822, 826, 832 use a fixed kernal size. The initial pooling layer 824 preserves the temporal information. A subsequent pooling layer 828 appears at the center of the network and compresses the temporal and spatial domains.

In FIG. 8 the 3D-CNN deep learning network can be used for vehicle speed estimation. The speed of the patrol vehicle 102 is determined in a vehicle speed estimation component 704. In one embodiment, the patrol vehicle speed is estimated using a monocular camera 314. The vehicle speed 816 is estimated using a network 800 with a 3D-CNN 802 that serves as the backbone in order to preserve the temporal information of the input signals 804. The 3D-CNN 802 includes a masked-attention map 808 that uses lane line markers to guide the model to focus on relevant features that help with the vehicle speed 816 computation.

An alternative deep learning network is a video vision transformer. A video vision transformer tokenizes a video using 3D Convolutional tubelet embeddings and further passes to multiple transformer encoders. The Transformer Encoder is trained with the spatio-temporal embeddings.

In one embodiment, the speed of the vehicle 102 with an onboard camera is estimated using an AI model, such as in the example CNN, video vision transformer, or variants of ResNet. Referring back to FIG. 6, in S608, tailgating detection can be ENABLED/DISABLED based on the vehicle speed estimated by the AI model. This is done to save computing resources that need not be spent in, for example, dense traffic conditions where vehicles move slow and inter-vehicle distances are minimal. The objective is to capture tailgating instances in highway scenarios with less traffic that enable vehicles to traverse in speeds greater than, for example, 100 km/hr.

When tailgating detection is ENABLED (Activated in S608), in S610, the present method searches for front 104 and tailgating vehicle 106 candidates. In S610 and S612, an AI model 706 can be used to detect and track wheels of the front 104 and tailgating 106 vehicles.

In S622, an environment vehicle speed estimation module determines the speed of the candidate vehicles. In S624, a distance estimation module estimates the tailgating distance. In one embodiment, the safety distance to be maintained is computed based on the speed of the tailgating vehicle. A faster speed requires a greater safety distance. If the tailgating distance is not in compliance with the safety distance (YES in S626), in S628, the tailgating event is logged and recorded in a memory of the embedded GPU device 420.

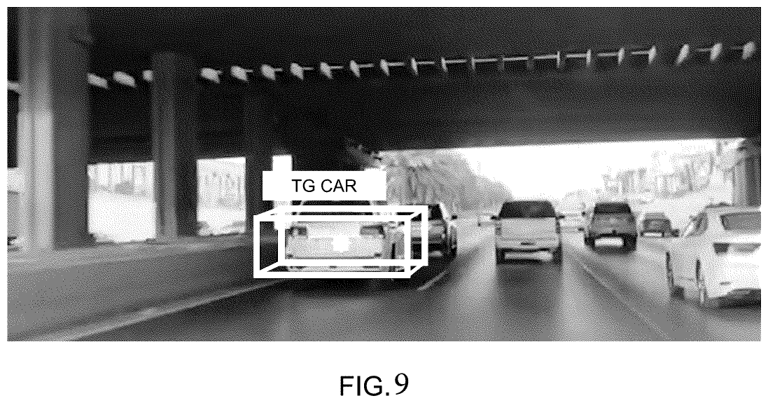

Referring back to step S610, the vehicles in the field of view of the camera 314 can be detected using a bounding box-based vehicle detection module. FIG. 9 illustrates bounding boxes for vehicle detection, in accordance with an exemplary aspect of the disclosure. The detection of front 104 and tailgating vehicles 106 can be further done using mathematical calculations on a vehicle cartesian coordinate system. The center of the bounding boxes of the vehicles 104, 106 give information about the positioning of the vehicles. In one embodiment, the detection of tailgating is performed for a high-speed lane which is the left most lane on the road. Hence, in the field of vision of the camera, the center coordinates which are towards the left of the central vertical line of the vehicle 102 are points of interest which belong to specific vehicles.

As in FIG. 9, once the front 104 and tailgating 106 vehicles are detected (S610), they are tracked (S612) until, in S614, one of them goes out of sight or it becomes so small in the camera 314 vision to be tracked properly. In one embodiment, in S612, tracking can be done using a Kalman filter based approach. The Kalman filter keeps track of the estimated state of the system and the variance or uncertainty of the estimate. The estimate is updated using a state transition model and measurements. In a case when the trailing vehicle 106 tries to overtake from the right, the front vehicle tracking may be turned off.

In some embodiments, in S616, the detected environment vehicle can be further sent to a vehicle model type recognizer. The vehicle type recognition is followed by, in S618, a look-up in a vehicles database which was previously collected from true sources. In S622, according to the recognized vehicle model, the vehicle's wheelbase can be measured.

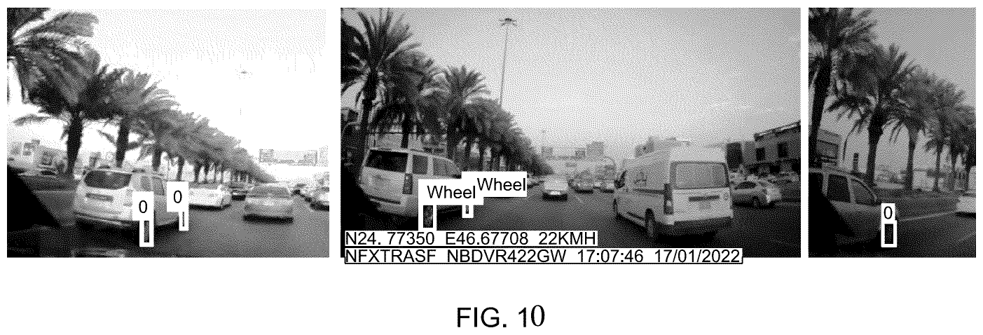

FIG. 10 illustrates wheel detection, for vehicle speed and distance estimation. In one embodiment, an object detection system 706 detects vehicles and can detect the wheels of the vehicles. One type of object detection system is a deep learning network called Faster R-CNN. See Shaoqing Ren, Kaiming He, Ross Girshick, and Jian Sun. Faster R-CNN: Towards Real-Time Object Detection with Region Proposal Networks. Advances in Neural Information Processing Systems, 28, 2015, incorporated herein by reference in its entirety. Faster R-CNN includes two modules. The first module is a deep fully convolutional network that proposes regions (Region Proposal Network), and the second module is the Fast R-CNN detector that uses the proposed regions. The RPN module tells the Fast R-CNN module where to look for objects.

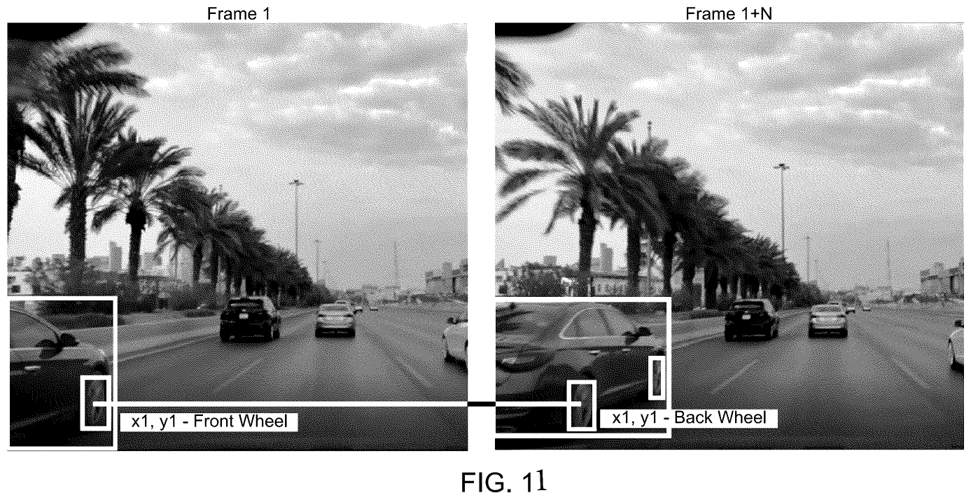

Positions of the wheels across image frames can be determined using the object detection system 706. FIG. 11 illustrates wheel detection across video frames of a moving vehicle, in accordance with an exemplary aspect of the disclosure. In Frame 1, the front wheel is detected. In Frame 1+N, the back wheel is detected.

The relative environment vehicle speed estimation component 708 calculates the relative speed of an environment vehicle r s using the output of the object detection system 706. The relative speed is calculated using the known pixel locations of the wheels for the vehicle in the image, their corresponding true wheelbase measurement, and the count of the number of frames taken to traverse the known wheelbase distance with the known camera FPS (Frames Per Second).

$${r}_{s} = \frac{{w}_{d}}{\frac{fn}{fps}}$$

wheelbase distance extracted from database of identified car model=w_{d}
camera FPS=fps
number of frames taken to traverse wheelbase distance=fₙ
relative speed of environment vehicle=rₛ.

The absolute environment vehicle speed estimation component 712 determines the absolute speed of an environment vehicle using the known patrol vehicle 102 speed v ego and the relative speed of environment vehicle r s.

Vₑₙᵥ=V_{ego}+/−rₛ

### Distance Estimation Between Front and Tailgating Vehicles:

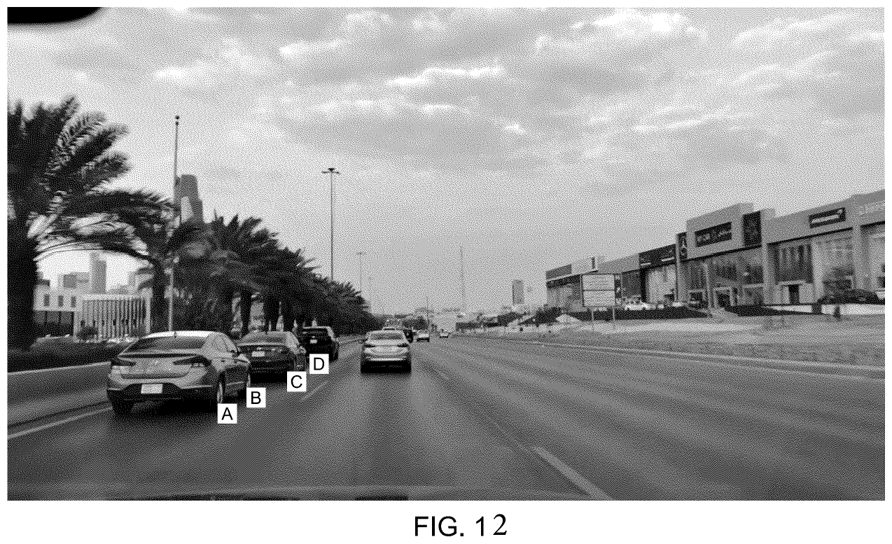

FIG. 12 illustrates wheel detection for distance estimation, in accordance with an exemplary aspect of the disclosure. With the known positions of the wheels using the Wheel Detector AI model 706, cross-ratios are used to calculate the tailgating distance.

Using Cross-Ratio,

$$\frac{A C \cdot BD}{BC \cdot AD} = \frac{{A}^{′} {C}^{′} \cdot {B}^{′} {D}^{′}}{{B}^{′} {C}^{′} \cdot {A}^{′} {D}^{′}}$$

However, in a real world scenario, the 4 points of the Front 104 and Tailgating 106 vehicle wheels are non-collinear as per the prelude for cross-ratio calculation.

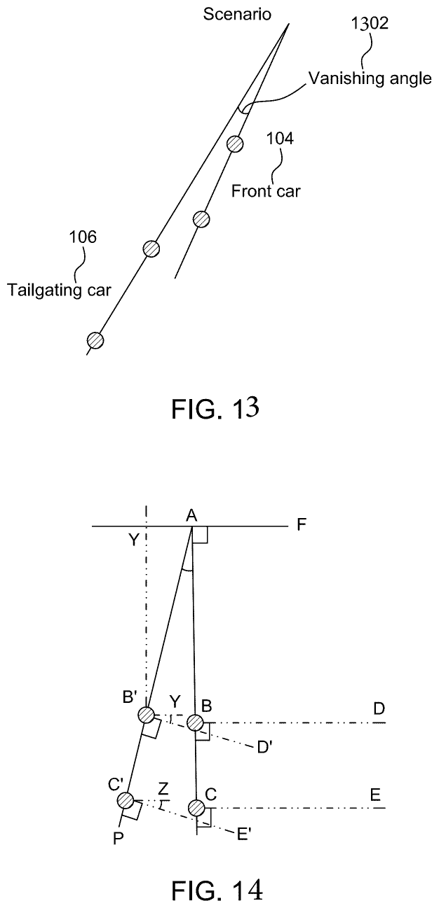

A method is provided that compensates and enforces collinearity. FIG. 13 illustrates a typical scenario for distance estimation during a tailgating event.

The tailgating vehicle 106 points need to be projected onto the line segment formed by the front vehicle 104 points in order to satisfy the cross-ratio constraint.

As shown in FIG. 13, the angle of projection of the tailgating vehicle 106 point that is estimated on the line segment formed by the front vehicle 104 points is the vanishing angle 1302 formed by the front vehicle 104 and tailgating vehicle 106 points.

A detailed explanation is provided using FIG. 14.

$${B}^{′} AB = {D}^{′} {B}^{′} Y = {E}^{′} {C}^{′} {Y}^{′} since AF ‖ {B}^{′} Y ‖ {C}^{′} Z$$

$$\text{=>} {B}^{′} AF = {C}^{′} {B}^{′} Y = {PC}^{′} Z$$

$$\text{=>} {B}^{′} AB + BAF ( 90 )$$

$$= {D}^{′} {B}^{′} Y + {D}^{′} {B}^{′} C ( 90 )$$

$$= {E}^{′} {C}^{′} Z + {E}^{′} {C}^{′} P ( 90 )$$

With this projection scheme utilized, the cross-ratio calculation is now valid, and the distance between the front vehicle 104 and tailgating vehicle 106 can now be estimated.

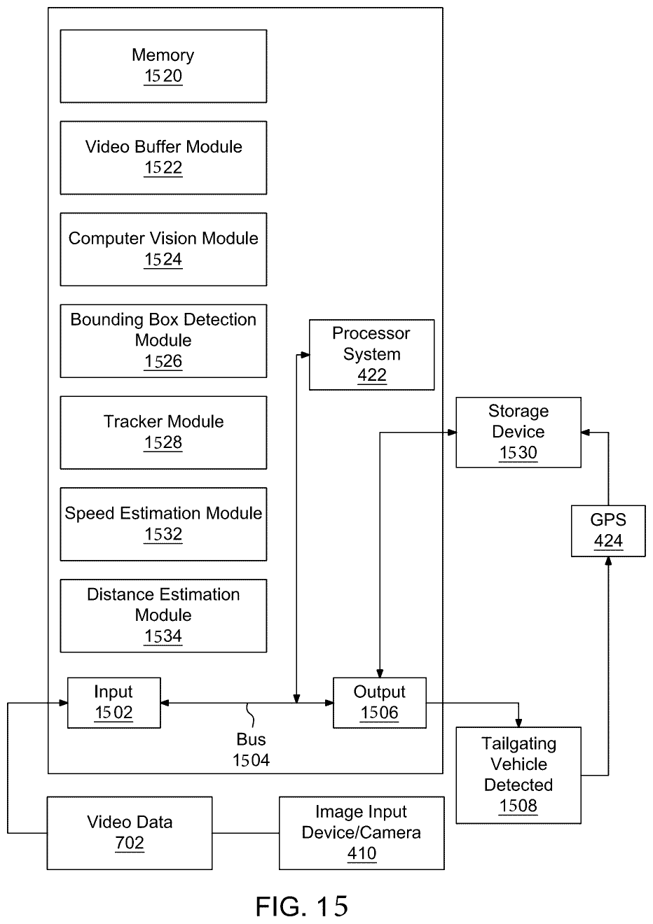

FIG. 15 is a block diagram of a tailgating detection system, in accordance with an exemplary aspect of the disclosure. The tailgating detection system diagram includes software flow during run time. An implementation of the tailgating detection system can include software modules stored in memory 1520. The software modules can include a video buffer module 1522, computer vision module 1524, bounding box detection module 1526, tracker module 1528, speed estimation module 1532, and distance estimation module 1534.

The video buffer module 1522 receives video stream as it is captured by the video camera 410 and accommodates for differences in speed between the captured video and vision processing.

The computer vision module 1524 performs machine vision algorithms. Machine vision algorithms can include linear regression, multi-layer neural network, or CNN (convolutional neural network).

The bounding box detection module 1526 uses annotated bounding boxes around other vehicles, vehicle wheels, and other visual objects to train a learning algorithm for computer vision models to understand what vehicles and other visual objects look like. Once trained, the bounding box detection module 1526 can detect other vehicles, wheels of other vehicles, for purposes of distance and speed measurement.

The tracker module 1528 is used to detect and track wheels of the front 104 and tailgating 106 vehicles. Once detected, the tracker module 1528 tracks the object that has been detected as the object moves. Location, distance and speed of detected objects can vary over time.

The speed estimation module 1532 estimates the speed of the patrol vehicle 102, and can estimate the speed of environment vehicles including front vehicle 104 and rear vehicle 106. The speed of the patrol vehicle 102 can be determined from sensors within the vehicle itself, for example, a speedometer. The vehicle speed determined by the speedometer is obtained through the CAN bus. However, the speed of environment vehicles needs to be obtained by other means. In one aspect, the speed of environment vehicles can be obtained by wireless communication with the environment vehicles. This aspect requires access to data that is maintained in the environment vehicle, which may not be allowed by the vehicle, or may require authentication to access internal vehicle data, or may require a physical connection to access internal vehicle codes.

As such, in one embodiment speed estimation module 1532 can estimate the speed of environment vehicles by way of detection of the environment vehicle and/or a part of a vehicle, which in one embodiment includes detection of environment vehicle wheels. In the embodiment, the speed estimation module 1532 uses computer vision and a video stream 702. In the embodiment, the speed estimation module 1532 calculates the relative speed of the environment vehicle based on the count of the number of frames taken to traverse the known wheelbase distance with the known camera frames per second. The speed estimation module 1532 determines the absolute speed of the environment vehicle using the estimated speed of the patrol vehicle 102 and the relative speed of the environment vehicle.

The distance estimation module 1534 estimates the tailgating distance. The tailgating distance is the distance between a front vehicle 104 and rear vehicle 106, and is within a safety distance. In one embodiment, the safety distance to be maintained is computed based on the speed of the tailgating vehicle 106. A faster speed requires a greater safety distance. The distance estimation module 1534 estimates an angle of projection of the tailgating vehicle 106 onto a line segment formed by the points of wheel positions of the front vehicle 104. The distance estimation module 1534 calculates the distance between the front vehicle 104 and the tailgating vehicle 106 using the projection.

A processor system 422 (e.g., system on chip, platform on chip, etc. containing a general purpose CPU and at least one special purpose processor, such as a vision processing unit, a machine learning engine or GPU). Video captured in an image input device/camera 410 is input as video frame data 702 via an input interface 1502. Internal devices are connected to a bus 1504. An output interface 1506 can connect to an external storage device 1530 and can output a result of tailgating detection 1508. A location of a tailgating event can be determined using a GPS 424. The tailgating event and its location is stored in the storage device 1530.

In order to detect a tailgating event, the present method takes into account the speed of the environment vehicles (S622) and the distance (S624) that is correspondingly maintained between them. In other words, the distance to be maintained between two vehicles is a function of the speed at which they are travelling. The present method combines the outputs from speed estimation module 1532 and distance estimation module 1534 in order to trigger the presence of a tailgating event (S628).

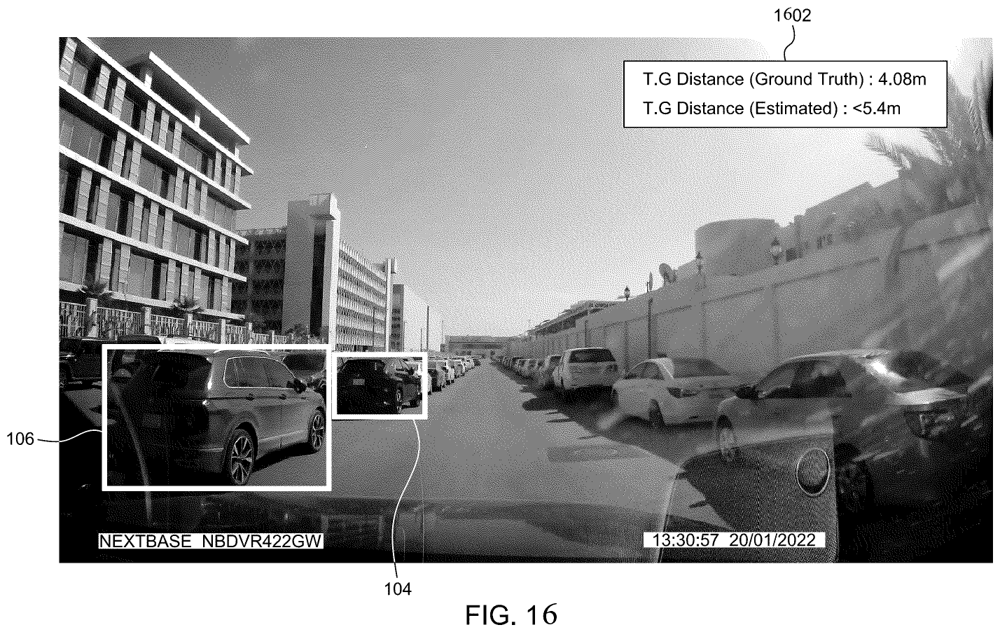

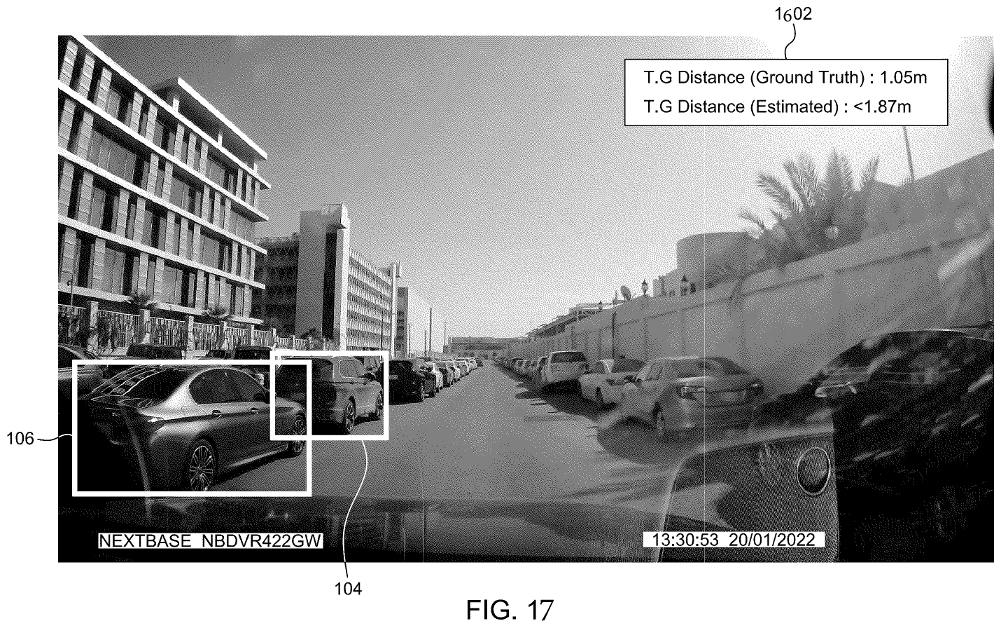

Some examples of the distance calculation by the distance estimation module are shown in FIG. 16 and FIG. 17 between a front vehicle 104 and a tailgating vehicle 106. FIG. 16 illustrates distance estimation of vehicles captured with the video camera. FIG. 17 illustrates distance estimation of vehicles captured with the video camera as the vehicle with camera moves along a road. In one embodiment, an image may be annotated with the distance measurement 1602.

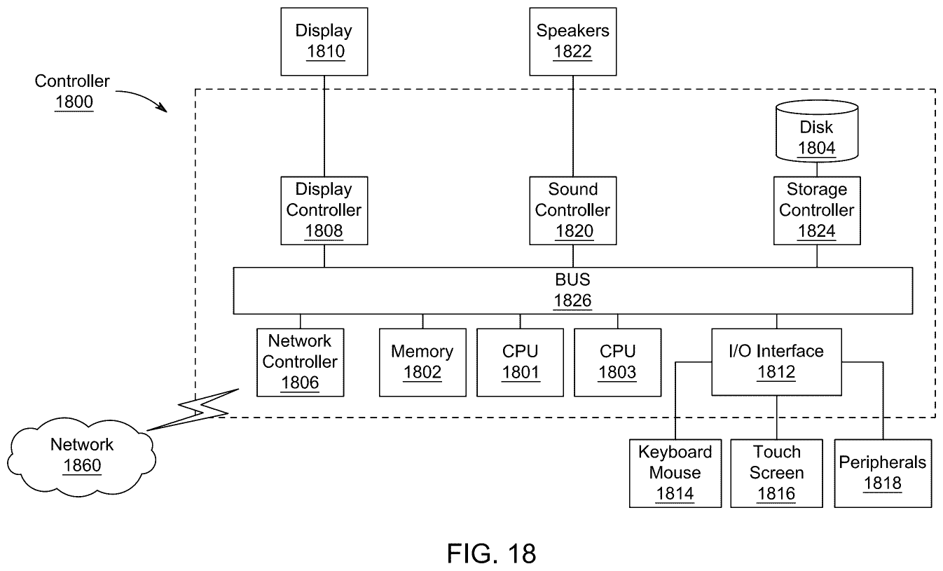

Next, further details of the hardware description of an exemplary computing environment according to embodiments is described with reference to FIG. 18.

In FIG. 18, a controller 1800 is described is representative of the apparatus 200 of FIG. 2 in which the controller is a computing device which includes a CPU 1801 which performs the processes described above/below.

FIG. 18 is an illustration of a non-limiting example of details of computing hardware used in the computing system, according to exemplary aspects of the present disclosure. In FIG. 18, a controller 1800 is described which is a computing device (that includes, the input 205, and the CNN model 220) and includes a CPU 1801 which performs the processes described above/below. The process data and instructions may be stored in memory 1802. These processes and instructions may also be stored on a storage medium disk 1804 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1801, 1803 and an operating system such as Microsoft Windows 7, UNIX, Solaris, LINUX, Apple MAC-OS and other systems known to those skilled in the art.

The hardware elements in order to achieve the computing device may be realized by various circuitry elements, known to those skilled in the art. For example, CPU 1801 or CPU 1803 may be a Xenon or Core processor from Intel of America or an Opteron processor from AMD of America, or may be other processor types that would be recognized by one of ordinary skill in the art. Alternatively, the CPU 1801, 1803 may be implemented on an FPGA, ASIC, PLD or using discrete logic circuits, as one of ordinary skill in the art would recognize. Further, CPU 1801, 1803 may be implemented as multiple processors cooperatively working in parallel to perform the instructions of the inventive processes described above.

The computing device in FIG. 18 also includes a network controller 1806, such as an Intel Ethernet PRO network interface card from Intel Corporation of America, for interfacing with network 1860. As can be appreciated, the network 1860 can be a public network, such as the Internet, or a private network such as an LAN or WAN network, or any combination thereof and can also include PSTN or ISDN sub-networks. The network 1860 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device further includes a display controller 1808, such as a NVIDIA GeForce GTX or Quadro graphics adaptor from NVIDIA Corporation of America for interfacing with display 1810, such as a Hewlett Packard HPL2445w LCD monitor. A general purpose I/O interface 1812 interfaces with a keyboard and/or mouse 1814 as well as a touch screen panel 1816 on or separate from display 1810. General purpose I/O interface also connects to a variety of peripherals 1818 including printers and scanners, such as an OfficeJet or DeskJet from Hewlett Packard.

A sound controller 1820 is also provided in the computing device such as Sound Blaster X-Fi Titanium from Creative, to interface with speakers/microphone 1822 thereby providing sounds and/or music.

The general-purpose storage controller 1824 connects the storage medium disk 1804 with communication bus 1826, which may be an ISA, EISA, VESA, PCI, or similar, for interconnecting all of the components of the computing device. A description of the general features and functionality of the display 1810, keyboard and/or mouse 1814, as well as the display controller 1808, storage controller 1824, network controller 1806, sound controller 1820, and general purpose I/O interface 1812 is omitted herein for brevity as these features are known.

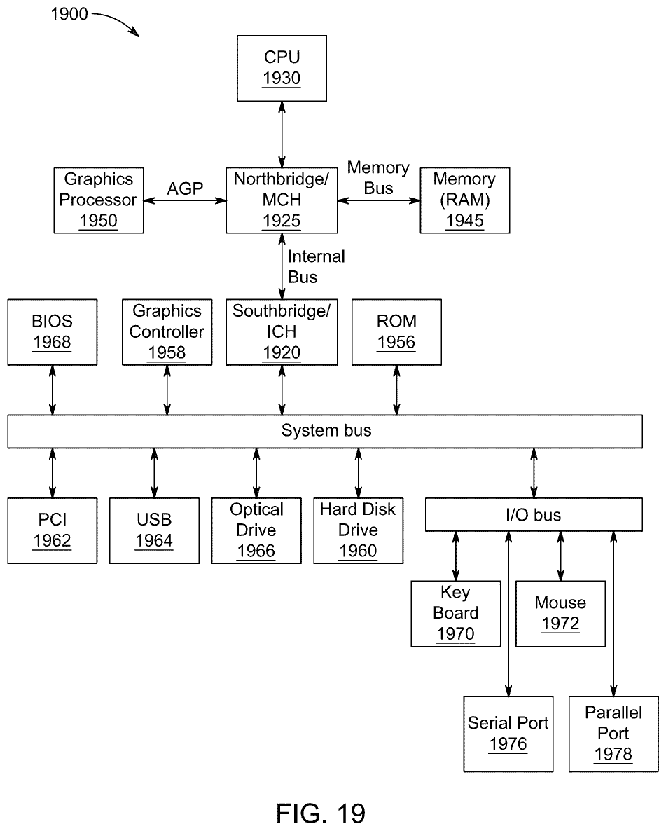

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 19.

FIG. 19 shows a schematic diagram of a data processing system 1900 used within the computing system, according to exemplary aspects of the present disclosure. The data processing system 1900 is an example of a computer in which code or instructions implementing the processes of the illustrative aspects of the present disclosure may be located.

In FIG. 19, data processing system 1980 employs a hub architecture including a north bridge and memory controller hub (NB/MCH) 1925 and a south bridge and input/output (I/O) controller hub (SB/ICH) 1920. The central processing unit (CPU) 1930 is connected to NB/MCH 1925. The NB/MCH 1925 also connects to the memory 1945 via a memory bus, and connects to the graphics processor 1950 via an accelerated graphics port (AGP). The NB/MCH 1925 also connects to the SB/ICH 1920 via an internal bus (e.g., a unified media interface or a direct media interface). The CPU Processing unit 1930 may contain one or more processors and even may be implemented using one or more heterogeneous processor systems.

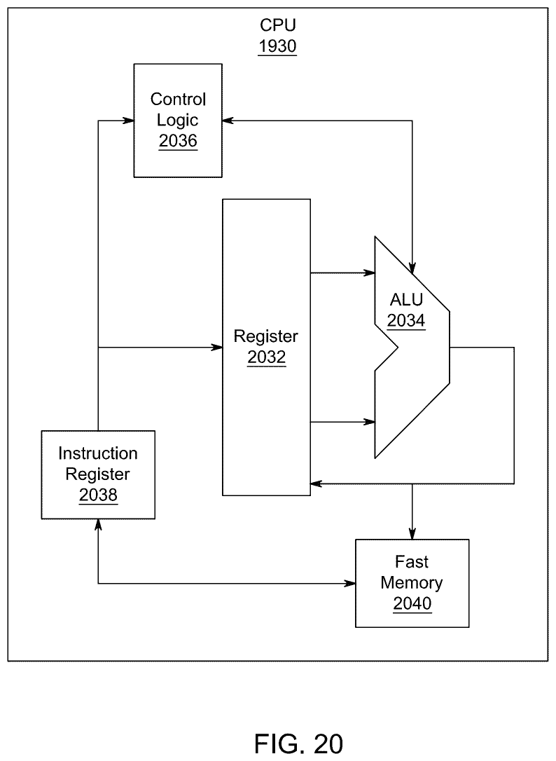

For example, FIG. 20 shows one aspects of the present disclosure of CPU 1930. In one aspects of the present disclosure, the instruction register 2038 retrieves instructions from the fast memory 2040. At least part of these instructions is fetched from the instruction register 2038 by the control logic 2036 and interpreted according to the instruction set architecture of the CPU 1930. Part of the instructions can also be directed to the register 2032. In one aspects of the present disclosure the instructions are decoded according to a hardwired method, and in another aspect of the present disclosure the instructions are decoded according to a microprogram that translates instructions into sets of CPU configuration signals that are applied sequentially over multiple clock pulses. After fetching and decoding the instructions, the instructions are executed using the arithmetic logic unit (ALU) 2034 that loads values from the register 2032 and performs logical and mathematical operations on the loaded values according to the instructions. The results from these operations can be feedback into the register and/or stored in the fast memory 2040. According to certain aspects of the present disclosures, the instruction set architecture of the CPU 1930 can use a reduced instruction set architecture, a complex instruction set architecture, a vector processor architecture, a very large instruction word architecture. Furthermore, the CPU 1930 can be based on the Von Neuman model or the Harvard model. The CPU 1930 can be a digital signal processor, an FPGA, an ASIC, a PLA, a PLD, or a CPLD. Further, the CPU 1930 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 19, the data processing system 1980 can include that the SB/ICH 1920 is coupled through a system bus to an I/O Bus, a read only memory (ROM) 1956, universal serial bus (USB) port 1964, a flash binary input/output system (BIOS) 1968, and a graphics controller 1958. PCI/PCIe devices can also be coupled to SB/ICH 1920 through a PCI bus 1962.

The PCI devices may include, for example, Ethernet adapters, add-in cards, and PC cards for notebook computers. The Hard disk drive 1960 and CD-ROM 1956 can use, for example, an integrated drive electronics (IDE) or serial advanced technology attachment (SATA) interface. In one aspects of the present disclosure the I/O bus can include a super I/O (SIO) device.

Further, the hard disk drive (HDD) 1960 and optical drive 1966 can also be coupled to the SB/ICH 1920 through a system bus. In one aspects of the present disclosure, a keyboard 1970, a mouse 1972, a parallel port 1978, and a serial port 1976 can be connected to the system bus through the I/O bus. Other peripherals and devices that can be connected to the SB/ICH 1920 using a mass storage controller such as SATA or PATA, an Ethernet port, an ISA bus, an LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

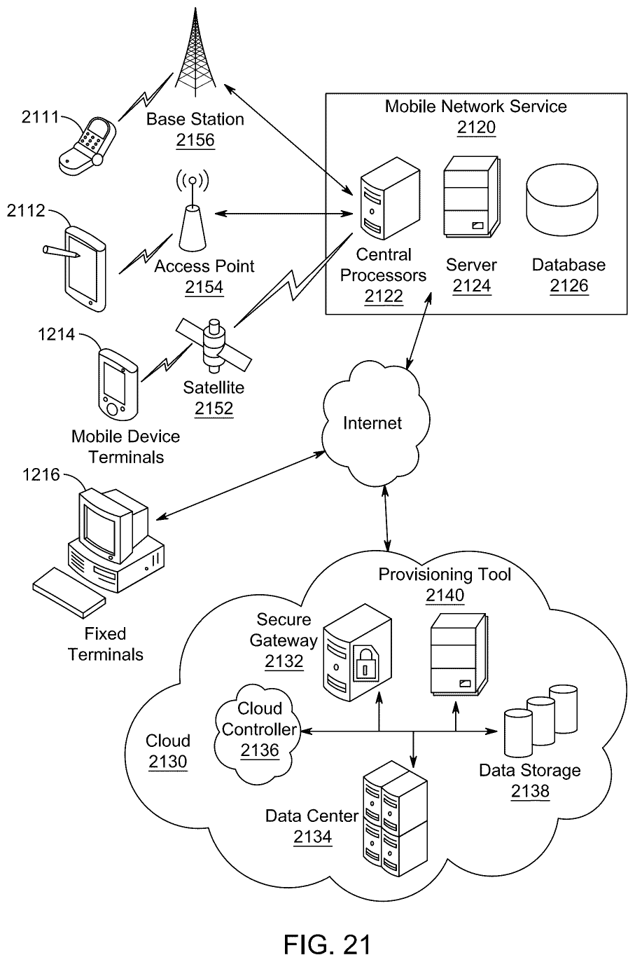

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 21, in addition to various human interface and communication devices (e.g., display monitors, smart phones, tablets, personal digital assistants (PDAs)). More specifically, FIG. 21 illustrates client devices including smart phone 2111, tablet 2112, mobile device terminal 2114 and fixed terminals 2116. These client devices may be commutatively coupled with a mobile network service 2120 via base station 2156, access point 2154, satellite 2152 or via an internet connection. Mobile network service 2120 may comprise central processors 2122, server 2124 and database 2126. Fixed terminals 2116 and mobile network service 2120 may be commutatively coupled via an internet connection to functions in cloud 2130 that may comprise security gateway 2132, data center 2134, cloud controller 2136, data storage 2138 and provisioning tool 2140. The network may be a private network, such as a LAN or WAN, or may be a public network, such as the Internet. Input to the system may be received via direct user input and received remotely either in real-time or as a batch process. Additionally, some aspects of the present disclosure may be performed on modules or hardware not identical to those described.

Numerous modifications and variations of the present invention are possible in light of the above teachings. It is therefore to be understood that within the scope of the appended claims, the invention may be practiced otherwise than as specifically described herein.

1. A tailgating detection system, comprising:
a single monocular camera mounted on a monitor vehicle;
an embedded computer system for determining a tailgating event based on images captured by the camera, the determining of the tailgating event including detecting and tracking wheels of at least one front candidate vehicle and at least one tailgating candidate vehicle and determining the respective speeds of the front and tailgating vehicle candidates relative to a speed of the monitor vehicle using a frame rate of the camera, wherein the embedded computer system is present in or on the monitor vehicle;
a location determining device, present in or on the monitor vehicle, for determining the location where the tailgating event occurred; and
a communication unit, present in or on the monitor vehicle, for transmitting a notification of the tailgating event including the location where the tailgating event occurred.

2. The tailgating detection system of claim 1, further comprising:
an input for enabling or disabling the determining of a tailgating event.

3. The tailgating detection system of claim 1, wherein the embedded computer system comprises a speed estimation module and a distance estimation module,
wherein the speed estimation module determines a speed of the front candidate vehicle and a speed of the tailgating candidate vehicle based on a speed of the monitor vehicle on which the camera is mounted,
wherein the distance estimation module determines a distance between the front candidate vehicle and the tailgating candidate vehicle,
wherein the determining the tailgating event is based the determined speed of the front candidate vehicle and the speed of the tailgating candidate vehicle, and the distance between the front candidate vehicle and the tailgating candidate vehicle.

4. The tailgating detection device of claim 1, further comprising:
a speed estimation module for determining the speed of the monitor vehicle on which the camera is mounted using video images captured by the camera.

5. The tailgating detection device of claim 3, further comprising:
an object detection network for detecting the wheels of the front candidate vehicle and the wheels of the tailgating candidate vehicle,
wherein the speed estimation module determines speed of the front candidate vehicle and speed of the tailgating candidate vehicle based on video frames containing the detected wheels and the frame rate of the camera.

6. The tailgating detection device of claim 3, wherein the distance estimation module determines the distance between the front candidate vehicle and the tailgating candidate vehicle based on a vanishing angle, wherein the vanishing angle is an angle of projection of the tailgating candidate vehicle onto a line segment formed by the front candidate vehicle.

7. The tailgating detection device of claim 3, wherein the speed estimation module is configured to perform a vehicle type recognition of each of the front candidate vehicle and the tailgating candidate vehicle, and retrieve vehicle wheelbase dimension information from a vehicle database based on recognized vehicle types, and
wherein the speed estimation module determines the speed of the front candidate vehicle and the speed of the tailgating vehicle based on the wheelbase dimension information.

8. The tailgating detection device of claim 3, wherein the distance determined by the distance estimation module is compared to a safety distance to determine that a tailgating event is occurring, and
wherein the notification of the tailgating event is transmitted upon the determination that the tailgating event is occurring.

9. The tailgating detection device of claim 1, wherein the camera is mounted on a dash of the vehicle,
wherein the camera captures continuous video images of a road including broken lane line markings on which the front candidate, tailgating candidate and monitor vehicles are traveling, and
wherein a speed estimation module determines the speed of the monitor vehicle using the continuous video images captured by the camera, with attention on the broken lane line markings.

10. The tailgating detection device of claim 1, wherein a tracer module tracks a front vehicle and a tailgating vehicle using a Kalman filter, and
wherein when the tailgating candidate vehicle overtakes the front candidate vehicle from right of the front vehicle, the front candidate vehicle tracking is turned off.

11. A method of tailgating detection, comprising:
capturing images of a scene in front of a monitor vehicle using a single monocular camera mounted on the monitor vehicle;
determining a tailgating event based on the captured images, including detecting and tracking wheels of at least one front candidate vehicle and at least one tailgating candidate vehicle and determining the respective speeds of the front and tailgating candidates relative to a speed of the monitor vehicle and using a frame rate of the camera, wherein an embedded computer system is present in or on the monitor vehicle;
determining, by a location determining device present in or on the monitor vehicle, a location where the tailgating event occurred; and
transmitting, by a communication unit present in or on the monitor vehicle, a notification of the tailgating event including the location where the tailgating event occurred.

12. The method of claim 11, further comprising:
enabling or disabling the determining of a tailgating event.

13. The method of claim 11, further comprising:
determining a speed of the front candidate vehicle and a speed of the tailgating candidate vehicle based on a speed of the monitor vehicle on which the camera is mounted;
determining a distance between the front candidate vehicle and the tailgating candidate vehicle; and
determining the tailgating event based the determined speed of the front candidate vehicle and the speed of the tailgating candidate vehicle, and the distance between the front candidate vehicle and the tailgating candidate vehicle.

14. The method of claim 11, further comprising:
determining the speed of the monitor vehicle on which the camera is mounted using video images captured by the camera.

15. The method of claim 11, further comprising:
detecting, by an object detection network, the wheels of the front candidate vehicle and the wheels of the tailgating candidate vehicle,
wherein the determining speed of the front candidate vehicle and speed of the tailgating candidate vehicle is based on video frames containing the detected wheels and the frame rate of the camera.

16. The method of claim 13, further comprising:
determining the distance between the front candidate vehicle and the tailgating candidate vehicle based on a vanishing angle, wherein the vanishing angle is an angle of projection of the tailgating candidate vehicle onto a line segment formed by the front candidate vehicle.

17. The method of claim 11, further comprising:
determining a vehicle type of each of the front candidate vehicle and the tailgating candidate vehicle, and retrieving vehicle wheelbase dimension information from a vehicle database based on determined vehicle types,
wherein the front candidate vehicle speed and the tailgating candidate vehicle speed are determined based on the wheelbase dimension information.

18. The method of claim 13, further comprising:
comparing the determined distance to a safety distance to determine that a tailgating event is occurring,
wherein the notification of the tailgating event is transmitted upon the determination that the tailgating event is occurring.

19. The method of claim 11, wherein the camera is mounted on a dash of the vehicle, the method further comprising:
continuously capturing, by the camera, video images of a road including broken lane line markings on which the front candidate, tailgating candidate and monitor vehicles are traveling; and
determining the speed of the vehicle using the continuous video images captured by the camera, with attention on the broken lane line markings.

20. The method of claim 11, further comprising:
tracking, by a tracer module, a front vehicle and a tailgating vehicle using a Kalman filter; and
when the tailgating vehicle overtakes the front vehicle from right of the front vehicle, tracking of the front vehicle is turned off.
